(19) United States
(12) Patent Application Publication
(10) Pub. No.: US 2020/0361165 A1
(43) Pub. Date: Nov. 19, 2020

(54) OPTICAL LENS WITH LASER INDUCED PERIODIC SURFACE STRUCTURE

(71) Applicant: SUN YANG OPTICS DEVELOPMENT CO., LTD., TAUYUAN CITY (TW)

(72) Inventors: SHENG-CHE WU, TAOYUAN CITY (TW); PING-TIEN WU, TAOYUAN CITY (TW); YEN-PIN TSAI, TAOYUAN CITY (TW)

(21) Appl. No.: 16/412,564

(22) Filed: May 15, 2019

(51) Int. Cl. B29D 11/00; B23K 26/0622; B23K 26/046

(52) U.S. Cl. CPC B29D 11/00384; B23K 26/046; B23K 26/0622; B29D 11/00134

(57) ABSTRACT

An optical lens with laser induced periodic surface structure has an optical lens made in one-piece with a surface and a convex surface. The convex surface has a microstructure of periodic surface induced and formed by laser. The periodic surface structure has a plurality of linear structures periodically arranged with an interval of 50 nm-1000 nm between each other and a height of 50 nm-500 nm.

### BACKGROUND OF THE INVENTION

### 1. Field of the Invention

The invention relates to an optical lens with laser induced periodic surface structure, particularly to a microstructure similar to a periodic structure formed on a convex surface of an optical lens. Such optical lens can be hydrophobic or hydrophilic; or it can be applied to reduce the reflective index of the lens. The microstructure is generated and formed by having an ultrafast laser emitted to a convex surface of the lens or to a thin film on the convex surface.

### 2. Description of the Related Art

Normally when forming an attachable material on a surface of the optical lens and generated a nanostructure on the attachable material, such attachable materials are usually photosensitive, macromolecule or low hardness, which are different from the materials of the optical lens. In practice, the refraction index of the optical lens and the attachable materials are different and therefore there is Fresnel loss and stray lights produced when light is penetrating through.

The manufacturing process of nanostructures such as photolithography and etching mainly includes the steps as following:

1. Applying a photoresist on a curved surface.

2. Performing photolithography to transfer a pattern on the photoresist.

3. Performing etching on the photoresist.

However, such process has problems stated as following.

1. It is not easy to apply the photoresist on the curved surface.

2. A photomask is required for the photolithography process but the pattern cannot be transferred onto the photoresist precisely due to the curved surface.

3. The etching process is incontrollable when performing on the curved surface.

To solve the difficulties caused by the curved surface, the plasma etching is applied to the curved surfaces. However, as the curve deviates further, the results of etching gets more different between the results at the central point and the results at both ends of the curve. Meanwhile, the arrangement of the nanostructure is generated randomly and the sizes are different as well; such structure would cause the optical functions of the optical lens unsteady. Therefore, it is obvious that the manufacturing methods performed on level surfaces cannot be applied on curve surfaces at all.

### SUMMARY OF THE INVENTION

It is a primary objective of the present invention to provide an optical lens with laser induced periodic surface structure that forms a microstructure similar to a periodic structure on a surface of an object by having laser with appropriate energy amount and polarization emitted to the surface of the object. In practice, the microstructure can be formed for different functions by adjusting the periodic features to be close enough or less than the wavelength of the laser, together with corresponding parameters of the focus extent, pulse numbers, scan rates and scan routes; and the microstructure can be formed on a large area of a surface and a curved surface.

Another objective of the present invention to provide an optical lens with laser induced periodic surface structure that is generated and formed by ultrafast laser which is at a rate of 10⁻¹⁵ seconds or even faster.

In order to achieve the above objectives, the optical lens with laser induced surface structure has an optical lens formed in one-piece and having a surface and a convex surface corresponding to said surface, said convex surface induced by laser to form a microstructure, said microstructure including a plurality of linear structures periodically arranged on said convex surface, said linear structure having an interval between each other ranging from 50 nm to 1000 nm and a height ranging from 50 nm to 500 nm.

The optical lens is made of either glass or polymer materials. The linear structures are in conic shapes protruding upwardly, or the linear structures are arranged in moth eyes structures protruding upwardly.

The optical lens further has a layer of thin film is further covered on the convex surface thereof with a refractive index matching a refractive index of materials of the optical lens.

The thin film is made of metals, semiconductors or dielectrics, and has a thickness of 20-500 nm.

The present invention further includes a laser device with parameters including pulse width, wavelength, focus extent, pulse repetition frequency, scan rate and energy density, and the laser parameters are adjustable to control formation of the periodic surface structure. The pulse width parameter is 1 fs-100 ps; the wavelength parameter is 300 nm-1500 nm; the focus extent parameter is 1 um-500 um; the pulse repetition frequency parameter is 1 Hz-10 MHz; the scan rate parameter is 40 um/s-5 m/s; and the energy density parameter is 0.01 J/cm²-50 J/cm².

Or the pulse width parameter is 20 fs-2000 fs; the wavelength parameter is 300 nm-1500 nm; the focus extent parameter is 1 um-500 um; the pulse repetition frequency parameter is 1 Hz-3 MHz; the scan rate parameter is 40 um/s-5 m/s; and the energy density parameter is 500 mJ/cm²-3000 mJ/cm².

The optical lens is made of glass; the pulse width parameter is 100 fs; the wavelength parameter is 800 nm; the focus extent parameter is 80 um; the pulse repetition frequency parameter is 62 MHz; the scan rate parameter is 160 um/s; and the energy density parameter is 995 mJ/cm².

A layer of thin film is further covered on the convex surface of the optical lens with a refractive index matching a refractive index of materials of the optical lens, said thin film made of ITO with a thickness of 180 nm, the pulse width parameter being 100 fs, the wavelength parameter being 800 nm, the focus extent parameter being 15 um, the pulse repetition frequency parameter being 2000 MHz; the scan rate parameter being 40 um/s; and the energy density parameter being 190 mJ/cm²-230 mJ/cm².

With structures disclosed above, the present invention has ultrafast laser emitted to the convex surface of the optical lens to form a microstructure similar to a periodic structure on the convex surface. Covering one or multiple layers of thin films on the convex surface of the optical lens before emitting the laser is also applicable; the thin film can be made of metals, semiconductors or dielectrics. By adjusting the parameters of the ultrafast laser, the formation of the microstructure can be generated and formed on a large area on a surface or even a curved surface to achieve the purpose of hydrophobicity or hydrophilicity; or it can be applied to reduce the reflective index of the lens.

### BRIEF DESCRIPTION OF THE DRAWINGS

FIG. 1 is a flow chart of the present invention;

FIG. 2A is a schematic diagram illustrating a laser device inducing microstructure on a convex surface of an optical lens according to the present invention;

FIG. 2B is a schematic diagram showing partial of the laser induced microstructure according to the present invention;

FIG. 2C is another schematic diagram showing partial of the laser induced microstructure according to the present invention;

FIG. 2D is a top plan view of the laser induced microstructure according to the present invention taken by an electronic microscope;

FIG. 2E is a curve diagram of reflective index of the laser induced microstructure according to the present invention;

FIG. 3A is a schematic diagram illustrating a laser device inducing microstructure on a convex surface of an optical lens according to a preferred embodiment of the present invention;

FIG. 3B is a schematic diagram showing partial of the laser induced microstructure according to the preferred embodiment of the present invention;

FIG. 3C is another schematic diagram showing partial of the laser induced microstructure according to the preferred embodiment of the present invention;

FIG. 3D is a top plan view of the laser induced microstructure according to the preferred embodiment of the present invention taken by an electronic microscope;

FIG. 3E is another top plan view of the laser induced microstructure according to the preferred embodiment of the present invention taken by an electronic microscope;

FIG. 3F is another top plan view of the laser induced microstructure according to the preferred embodiment of the present invention taken by an electronic microscope;

FIG. 3G is another top plan view of the laser induced microstructure according to the preferred embodiment of the present invention taken by an electronic microscope; and

FIG. 3H is another curve diagram of reflective index of the laser induced microstructure according to the present invention.

### DETAILED DESCRIPTION OF THE PREFERRED EMBODIMENT

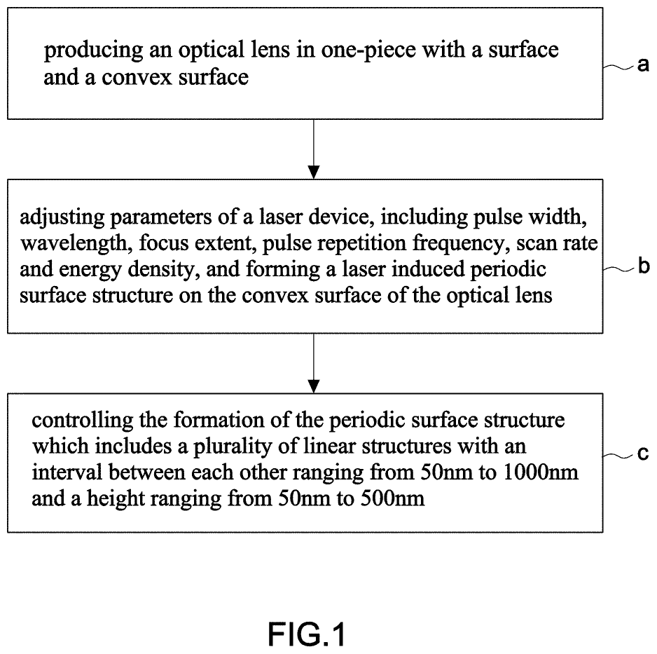

Referring to FIG. 1, the present invention is an optical lens with laser induced surface structure generated and formed by the following steps: a. producing an optical lens in one-piece. The optical lens includes a surface and a convex surface. b, adjusting parameters of a laser device and forming a laser induced periodic surface structure on the convex surface of the optical lens. The parameters include pulse width, wavelength, focus extent, pulse repetition frequency, scan rate and energy density. And c, controlling the formation of the periodic surface structure in formation arrangement and size. The periodic surface structure includes a plurality of linear structures with an interval between each other ranging from 50 nm to 1000 nm and a height ranging from 50 nm to 500 nm.

According to the manufacturing method above, the present invention includes an optical lens 10 formed in one-piece and having a surface 101 and a convex surface 102 corresponding to the surface 101. The convex surface 102 is induced by laser to form a microstructure 30; the microstructure 30 includes a plurality of linear structures 31 periodically arranged on the convex surface 102 and the linear structures 31 has an interval D between each other ranging from 50 nm to 1000 nm and a height H ranging from 50 nm to 500 nm.

In a preferred embodiment, the pulse width parameter 211 is 1 fs-100 ps; the wavelength parameter 212 is 300 nm-1500 nm; the focus extent parameter 213 is 1 um-500 um; the pulse repetition frequency parameter 214 is 1 Hz-10 MHz; the scan rate parameter 215 is 40 um/s-5 m/s; and the energy density parameter 216 is 0.01 J/cm²-50 J/cm². In another preferred embodiment, the pulse width parameter 211 is 20 fs-2000 fs; the wavelength parameter 212 is 300 nm-1500 nm; the focus extent parameter 213 is 1 um-500 um; the pulse repetition frequency parameter 214 is 1 Hz-3 MHz; the scan rate parameter 215 is 40 um/s-5 m/s; and the energy density parameter 216 is 500 mJ/cm²-3000 mJ/cm².

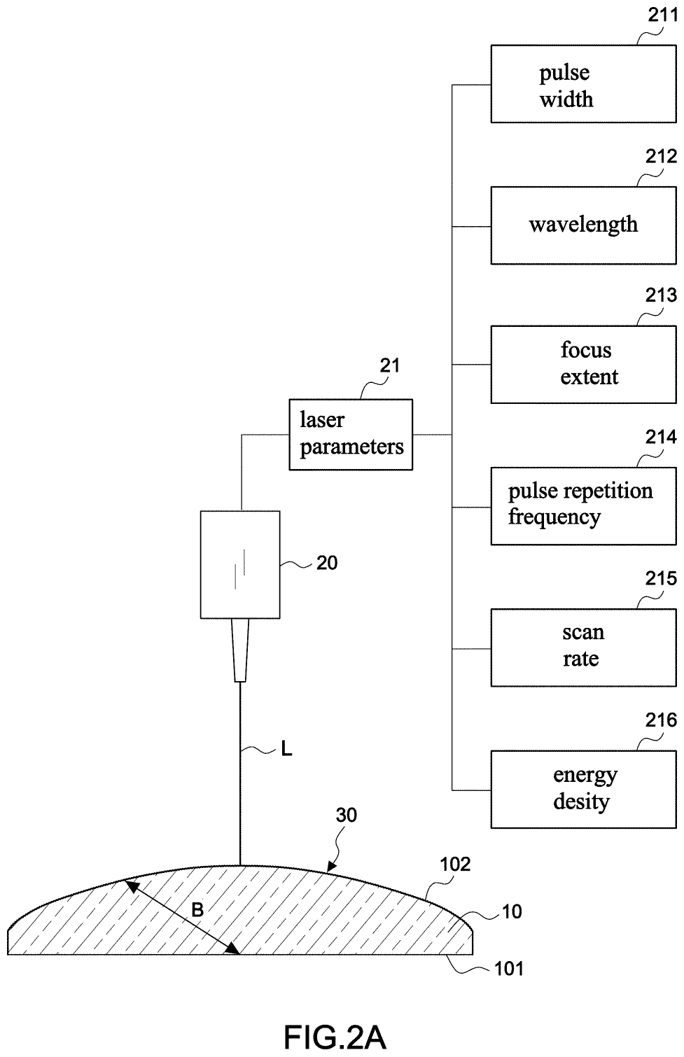

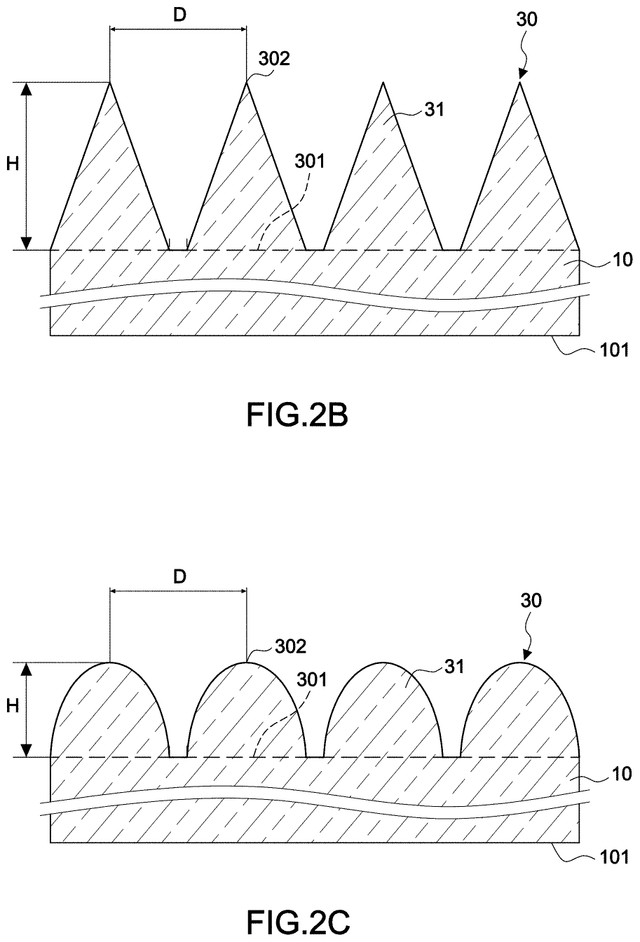

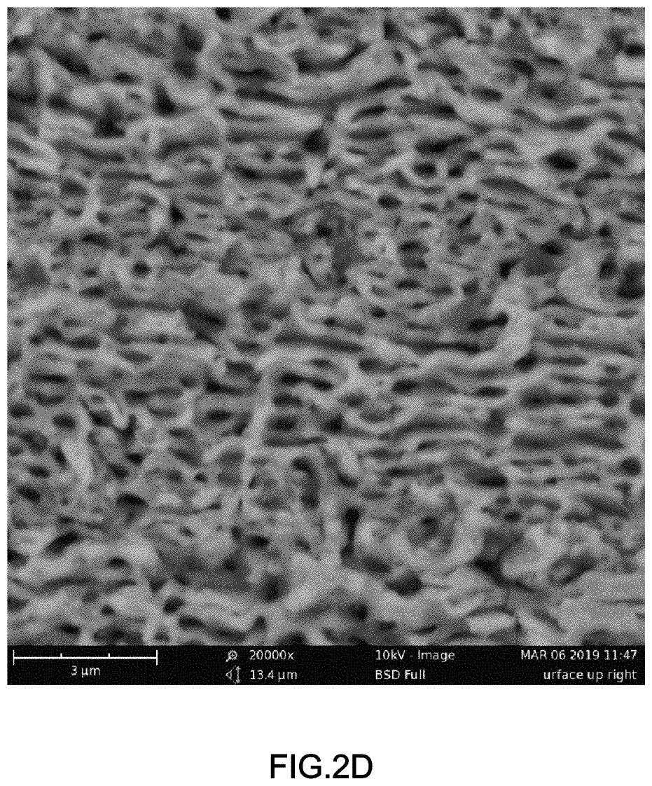

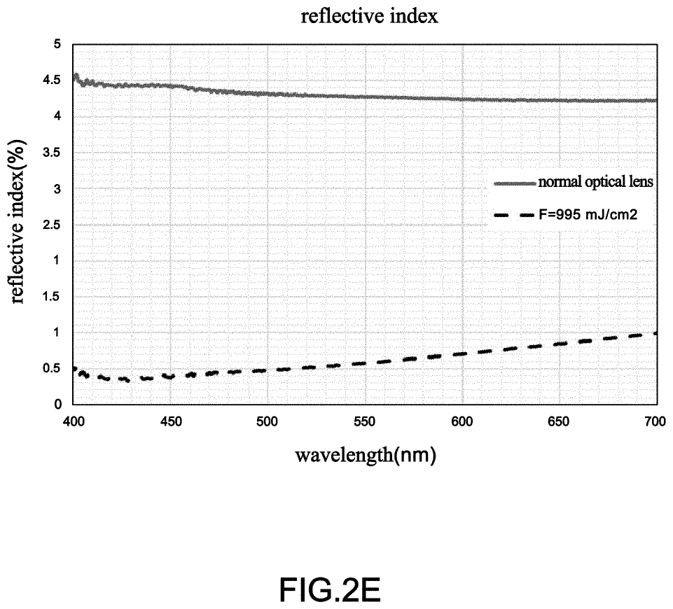

Furthermore, the optical lens 10 is made of glass or polymer materials. With reference to FIG. 2, in a first embodiment, the optical lens 10 is made of glass such as BK7 glass and the parameters 21 of the laser device 20 are: the pulse width parameter 211—100 fs, the wavelength parameter 212—800 nm, the focus extent parameter 213—80 um, the pulse repetition frequency parameter 214—62 MHz, the scan rate parameter 215—160 um/s, and the energy density parameter 216—995 mJ/cm². The microstructure 30 formed on the convex surface 102 of the optical lens 10 induced by the laser L is shown in FIG. 2B. The linear structures 31 are in conic shapes and the sectional surface area of the linear structures 31 are protruding upwardly from a bottom 301 to a top 302. Or it can also be the structure shown in FIG. 2C—the linear structures 31 are arranged in moth eyes structures and the sectional surface area of the linear structures 31 are protruding upwardly from a bottom 301 to a top 302. But the present invention is not limited to such application.

FIG. 2D shows an image of the laser induced periodic surface structure 30 under an electronic microscope. FIG. 2E is a comparison of the reflective index of the convex surface 102 between normal optical lens 10 and the one with laser induced periodic surface structure 30. The optical lens 10 with the microstructure 30 can reduce the reflective index and eliminate the stray lights within the lens 10.

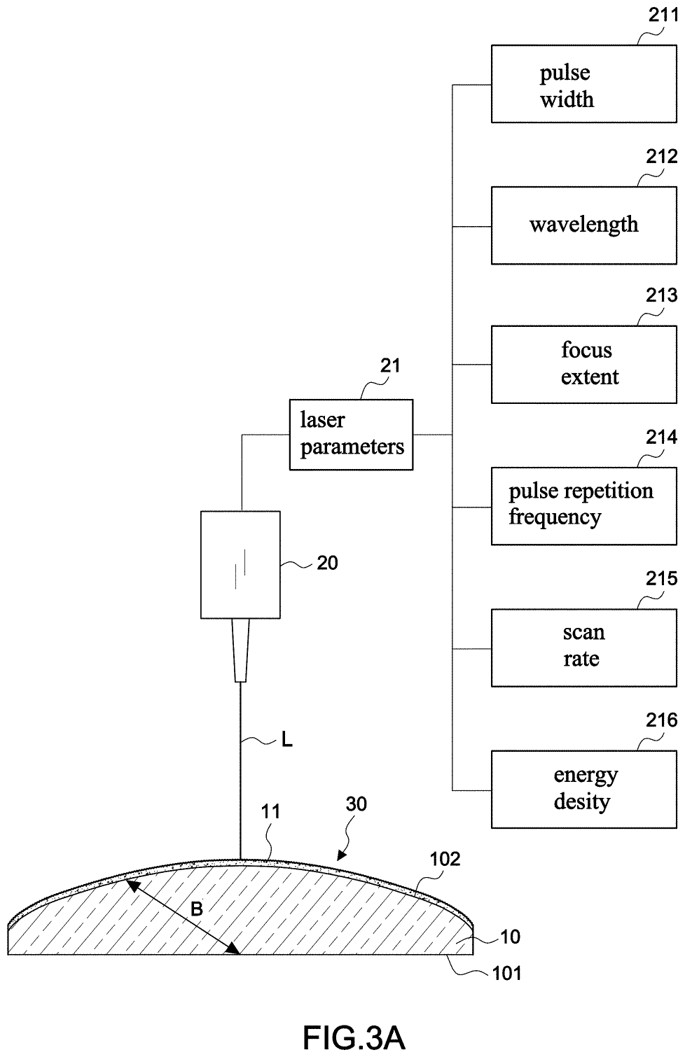

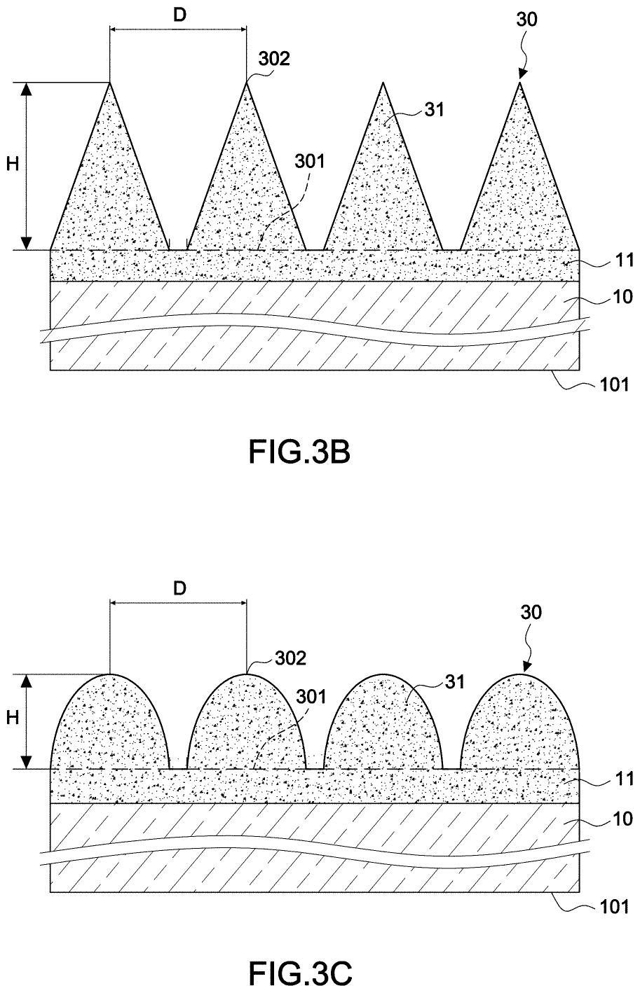

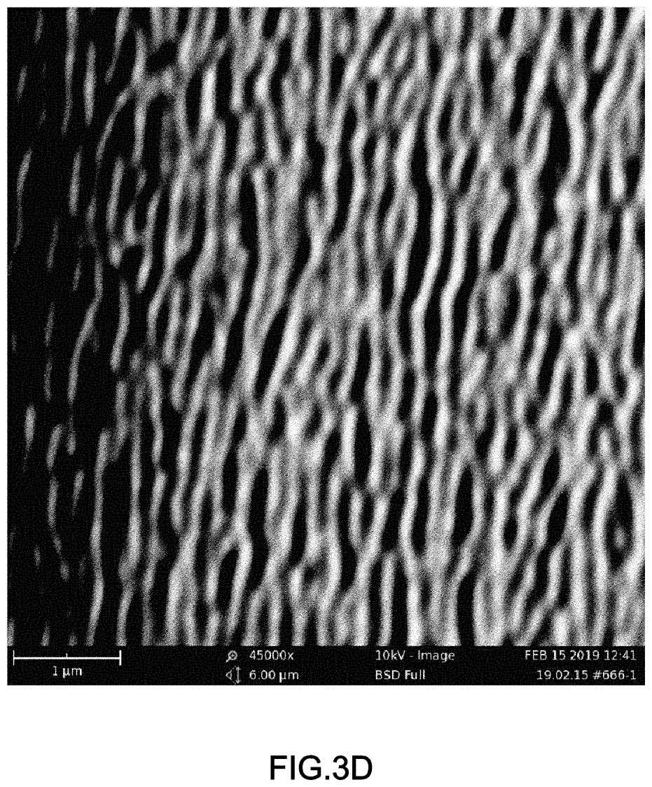

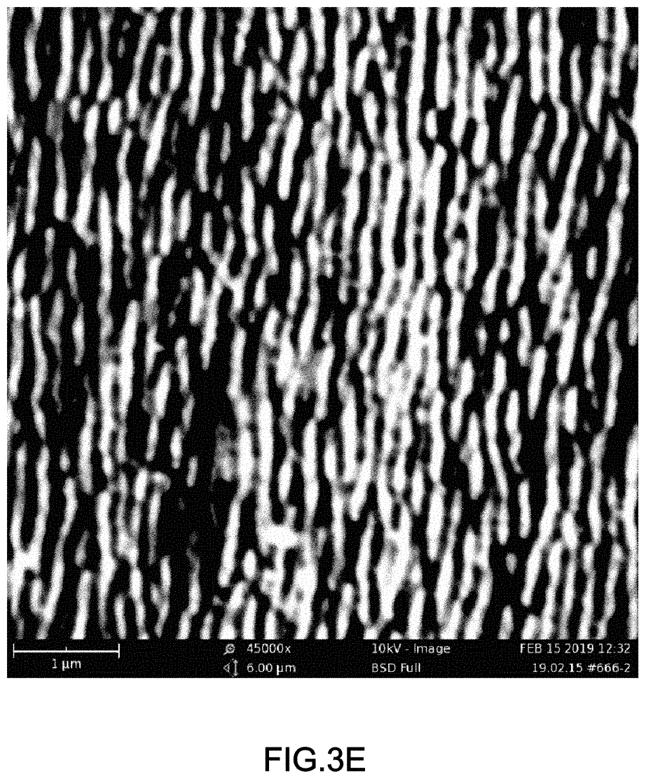

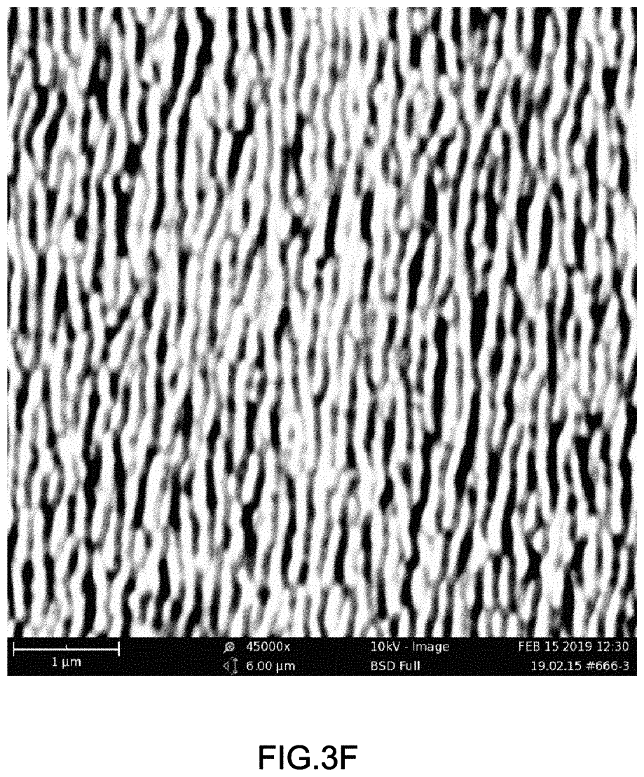

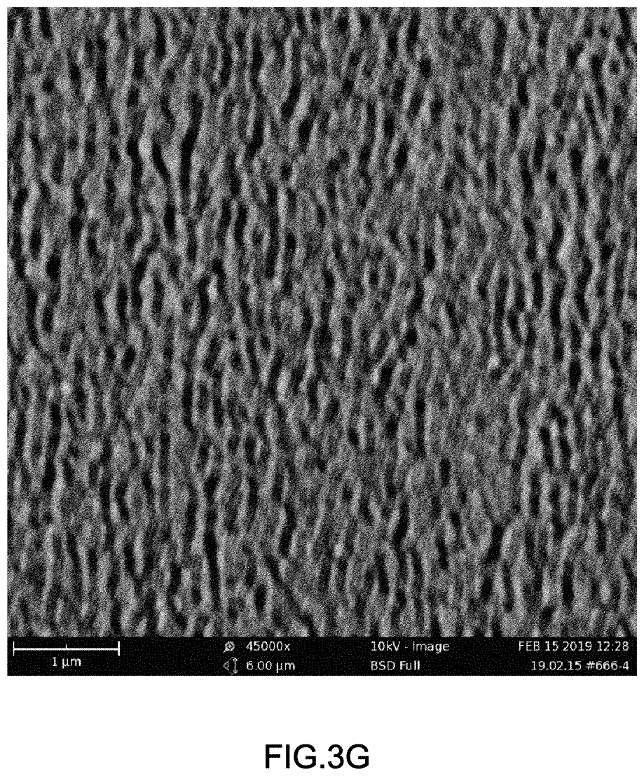

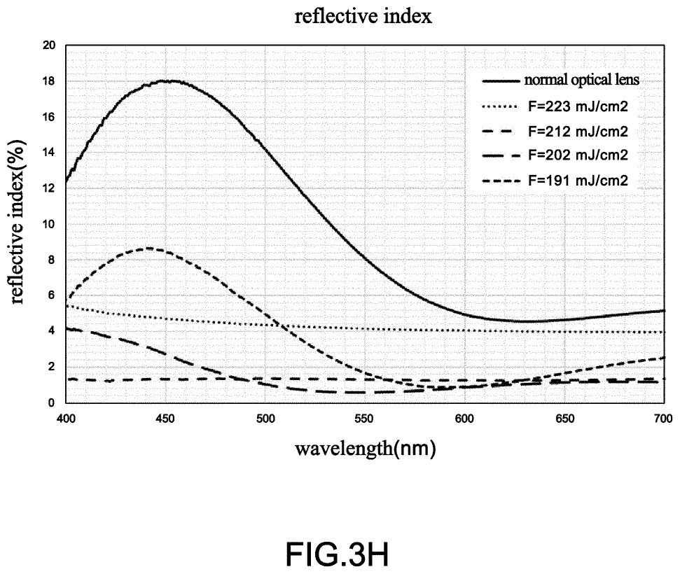

A layer of thin film 11 is further covered on the convex surface 102 with a refractive index matching a refractive index of materials of the optical lens 10. The thin film 11 has a thickness of 20-500 nm or 30-300 nm and is made of metals, semiconductors or dielectrics. Referring to FIG. 3A, in a second embodiment, thin film 11 is made of ITO with a thickness of 180 nm, and the parameters 21 of the laser device 20 is the pulse width parameter 211 being 100 fs, the wavelength parameter 212 being 800 nm, the focus extent parameter 213 being 15 um, the pulse repetition frequency parameter 214 being 2000 MHz; the scan rate parameter 215 being 40 um/s; and the energy density parameter 216 being 190 mJ/cm²-230 mJ/cm². The microstructure 30 formed on the convex surface 102 of the optical lens 10 induced by the laser L is shown in FIG. 3B. The linear structures 31 are in conic shapes and the sectional surface area of the linear structures 31 are protruding upwardly from a bottom 301 to a top 302. Or it can also be the structure shown in FIG. 2C—the linear structures 31 are arranged in moth eyes structures and the sectional surface area of the linear structures 31 are protruding upwardly from a bottom 301 to a top 302. But the present invention is not limited to such application.

Further referring to FIGS. 3D, 3E, 3F and 3G, the direction of polarization is horizontal and the energy density 216 of each figure is respectively 223 mJ/cm², 212 mJ/cm², 202 mJ/cm² and 191 mJ/cm². After scanning, the microstructure 30 can be observed by electronic microscopes. FIG. 3H is a comparison of the reflective index of the thin film 11 on a normal optical lens 10 and on other one with the laser induced periodic surface structure 30. The thin film 11 on the optical lens 10 with the microstructure 30 can reduce the reflective index and eliminate other lights within the lens 10.

In the first and second embodiments, the upwardly protruding linear structures 31 can intercept external water or dirts at the top 302 and avoid contact area of the external water or dirts with the optical lens 10 by controlling the size thereof, thereby achieving the feature of hydrophobic. Or the protruding linear structures 31 can be controlled in size to allow external water to flow into the internals D between the linear structures 31, thereby achieving the feature of hydrophilic.

With the structures disclosed above, the laser induced periodic surface structure 30 generated on the convex surface 102 of the optical lens 10 further forms an infrastructure B together with the surface 101 of the optical lens 10. Such infrastructure B has advantages as following.

1. The infrastructure B is formed to be in one-piece for a gradual change of the refractive index to the optical lens 10 to avoid the Fresnel loss caused in the process. In practices, this can reduce the stray lights in the images.

2. The one or multiple thin films 11 on the convex surface 102 can be those with materials having a refractive index close to the one of the infrastructure B, so as to reduce the Fresnel loss in the process.

3. The traditional manufacturing process cannot be applied on curved surfaces, but the present invention is able to adjust the scanning route and focus point to generate the microstructure on the convex surface in a large scale.

4. The traditional manufacturing process has to go through manufacturing photomask, photolithography and etching and form the microstructure with careful control of the quality and other factors at each stage. While with the laser to manufacture the microstructure, the final produce of the manufacturing process can be simply controlled by setting the parameters of the laser device without going through other processes and applying the chemical liquids of photoresist and etchant In other words, there is almost no wastes in the manufacturing process according to the present invention, making it simple and eco-friendly.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An optical lens with laser induced periodic surface structure, comprising:
an optical lens formed in one-piece and having a surface and a convex surface corresponding to said surface, said convex surface induced by laser to form a microstructure, said microstructure including a plurality of linear structures periodically arranged on said convex surface, said linear structure having an interval between each other ranging from 50 nm to 1000 nm and a height ranging from 50 nm to 500 nm.

2. The optical lens with laser induced periodic surface structure as claimed in claim 1, wherein the optical lens is made of either glass or polymer materials.

3. The optical lens with laser induced periodic surface structure as claimed in claim 1, wherein the linear structures are in conic shapes protruding upwardly.

4. The optical lens with laser induced periodic surface structure as claimed in claim 1, wherein the linear structures are arranged in moth eyes structures protruding upwardly.

5. The optical lens with laser induced periodic surface structure as claimed in claim 1, wherein a layer of thin film is further covered on the convex surface of the optical lens with a refractive index matching a refractive index of materials of the optical lens.

6. The optical lens with laser induced periodic surface structure as claimed in claim 5, wherein the thin film is made of metals, semiconductors or dielectrics.

7. The optical lens with laser induced periodic surface structure as claimed in claim 5, wherein the thin film has a thickness of 20-500 nm.

8. The optical lens with laser induced periodic surface structure as claimed in claim 1, wherein the present invention further includes a laser device with parameters including pulse width, wavelength, focus extent, pulse repetition frequency, scan rate and energy density, and the laser parameters are adjustable to control formation of the periodic surface structure.

9. The optical lens with laser induced periodic surface structure as claimed in claim 8, wherein the pulse width parameter is 1 fs-100 ps; the wavelength parameter is 300 nm-1500 nm; the focus extent parameter is 1 um-500 um; the pulse repetition frequency parameter is 1 Hz-10 MHz; the scan rate parameter is 40 um/s-5 m/s; and the energy density parameter is 0.01 J/cm²-50 J/cm².

10. The optical lens with laser induced periodic surface structure as claimed in claim 8, wherein the pulse width parameter is 20 fs-2000 fs; the wavelength parameter is 300 nm-1500 nm; the focus extent parameter is 1 um-500 um; the pulse repetition frequency parameter is 1 Hz-3 MHz; the scan rate parameter is 40 um/s-5 m/s; and the energy density parameter is 500 mJ/cm²-3000 mJ/cm².

11. The optical lens with laser induced periodic surface structure as claimed in claim 8, wherein the optical lens is made of glass; the pulse width parameter is 100 fs; the wavelength parameter is 800 nm; the focus extent parameter is 80 um; the pulse repetition frequency parameter is 62 Hz; the scan rate parameter is 160 um/s; and the energy density parameter is 995 mJ/cm².

12. The optical lens with laser induced periodic surface structure as claimed in claim 8, wherein a layer of thin film is further covered on the convex surface of the optical lens with a refractive index matching a refractive index of materials of the optical lens, said thin film made of ITO with a thickness of 180 nm, the pulse width parameter being 100 fs, the wavelength parameter being 800 nm, the focus extent parameter being 15 um, the pulse repetition frequency parameter being 2000 Hz; the scan rate parameter being 40 um/s; and the energy density parameter being 190 mJ/cm²-230 mJ/cm².
